(19) United States
(12) Patent Application Publication
(10) Pub. No.: US 2025/0132836 A1
(43) Pub. Date: Apr. 24, 2025

(54) A DUAL SMALL FORM-FACTOR PLUGGABLE DOUBLE-DENSITY MULTIPLE PASSIVE OPTICAL NETWORK MODULE

(71) Applicant: ALTICE LABS, S.A., Aveiro (PT)

(72) Inventors: Cláudio Emanuel GOMES FERREIRINHO LIMA RODRIGUES, Aveiro (PT); Paulo Jorge DA COSTA MÄO CHEIA, Aveiro (PT); Joaquim Fernando VALE E SERRA, Aveiro (PT); Alfonso Carlos ANTERO MIRANDA FIGUEIREDO, Aveiro (PT); Luis Miguel AMARAL HENRIQUES, Aveiro (PT); Tiago Manuel CAMPOS, Aveiro (PT)

(21) Appl. No.: 18/723,158

(22) PCT Filed: Dec. 22, 2022
(86) PCT No.: PCT/IB2022/062674

§ 371 Date: Jun. 21, 2024

(30) Foreign Application Priority Data
Dec. 23, 2021 (PT) 117681

(51) Int. Cl. H04B 10/40; G02B 6/42; H04B 10/25

(52) U.S. Cl. CPC H04B 10/40; G02B 6/4246; G02B 6/4281; H04B 10/25891

(57) ABSTRACT

The present invention relates to a Dual Small Form-Factor Pluggable Double Density Multiple Passive Optical Network Module, projected to provide a connection for XGS-PON and GPON, and to be incorporated in any state-of-the-art SFP-DD transceiver host to allow double multi-PON OLT channels. The module comprises a case housing a specific set of technical elements such as two multiple PON-bidirectional optical subassemblies, forty pins high-speed electrical interface, and all the necessary electronic circuits, printed circuit board and flex-printed circuit board to ensure proper assembly and electronic performance of all elements.

### FIELD OF THE INVENTION

The present invention is enclosed in the area of Gigabit passive optical network (GPON) and 10 Gigabit-capable symmetric passive optical network (XGS-PON) optical line terminals (OLT), particularly in the field of small form-factor pluggable modules double density (SFP-DD) and multiple PON optical modules.

### PRIOR ART

Gigabit-capable Passive Optical Network (GPON) has been widely spread among operators allowing the distribution of high bandwidth, large coverage, and providing high efficiency to deliver broadband. Based on International Telecommunication Union-Telecommunication Standardization Sector (ITU-T) G.984.x. GPON-OLTs commonly use small form-factor pluggable (SFP) transceiver hosts equipped with SFPs in a single fiber bidirectional SC connector configuration for carrying out the transmission and reception of the passive optical network (PON) data.

10 Gigabit-capable symmetric Passive Optical Network (XGS-PON) is spreading among operators allowing the distribution of very high bandwidth, large coverage, and providing high efficiency to deliver broadband. It is a PON technology capable of coexisting in the same physical network with legacy GPON ITU-T G. 984.x—by using different downstream and upstream wavelengths. XGS-PON is based on ITU-T G.907.x. XGS-PON Optical Line Terminals (OLTs) commonly use SFP plus transceiver hosts equipped with 10 Gigabit SFP plus in a single fiber bidirectional SC connector configuration for carrying out the transmission and reception of the 10 Gigabit passive optical network (PON) data.

Multiple-PON Optical Line Terminals (MPM-OLTs), XGS-PON plus GPON OLTs, commonly use SFP plus transceiver hosts equipped with 10 Gigabit and 2.5 Gigabit MPM SFP plus in a single fiber bidirectional SC connector configuration for carrying out the transmission and reception of the 2.5 Gigabit and 10 Gigabit passive optical network (PON) data.

SFPs plus comprise a metallic case, a printed circuit board (PCB), a Bi-Directional Optical Sub-Assembly (BOSA), and flexible PCBs to connect the BOSA to the PCB. BOSA comprises a metal housing with a Transmitter Optical Sub-Assemblies (TOSAs) for optical transmitting, a Receiver Optical Sub-Assemblies (ROSAs) for optical receiving, an optical fiber or an optical connector to connect an optical fiber which connects to the external network, and a device used to route the light to and from the optical fiber.

### Problem to be Solved

Current Multiple-PON-Modules (MPM) optical transceiver for GPON and XGS-PON support just one PON coexistence connection, this is, by employing a bidirectional SC connector, a single SFP+ is adapted to feed a GPON and XGS-PON network, limiting the number of users connected to the said host and thereby limiting also its density.

The present invention addresses the above problem.

### SUMMARY OF THE INVENTION

The present invention relates to a Dual Small Form-factor Pluggable Double-Density Multiple Passive Optical Network Module (DSFPDD-MPM), projected to provide a connection to two optical fiber connectors of a PON and to be incorporated in any state-of-the-art MPM-OLT supporting GPON and XGS-PON.

Due to the set of technical features that characterizes the DSFPDD-MPM optical module developed, it is possible to double the density of an MPM transceiver, that is, for the same cage space, it allows to double the number of PON technologies (XGS-PON+GPON & XGS-PON+GPON). The DSFPDD-MPM allows the transmitting and receiving of 2 plus 2 PON channels in a single optical transceiver.

### DESCRIPTION OF FIGURES

FIG. 1 is a schematic diagram of the DSFPDD-MPM optical module developed, according to certain aspects of the invention. The numerical references represent:
10—DSFPDD-MPM optical module;
110—Multiple-PON (XGS-PON plus GPON) bidirectional optical subassembly;
111—electrical circuit;
112—high-speed electrical interface;
113—case;
114—flex-printed circuit board;
115—printed circuit board.

FIG. 2Erro! A origem da referência não foi encontrada. is a schematic diagram of the DSFPDD-MPM module's control unit, according to certain aspects of the invention. The numerical references represent:
111—control unit;
112—high-speed electrical interface;
114—flex-printed circuit board;
210—modulation sub-unit;
220—microcontroller;
230—power supply.

FIG. 3 is a diagram of the DSFPDD-MPM module contact assignment of the 40 pins high-speed electrical interface (HSEI) to the SFPDD transceiver host to support the dual GPON and XGS-PON according to certain aspects of the invention.

The module contact assignment is defined as:
Pin number 1—GPON1_TD+—Transmit Non-Inverted GPON channel one Data Input;
Pin number 2—GPON1_TD−—Transmit Inverted GPON channel one Data Input;
Pin number 3—GND-Module ground;
Pin number 4—SDA1—First 2-Wire Serial Interface Data Line;
Pin number 5—SCL1—First 2-Wire Serial Interface Clock;
Pin number 6—GPON1 RD−—Receive Burst Mode Inverted GPON channel one Data output;
Pin number 7—Reset/Rateselect1—Reset Receiver Burst Mode XGS-PON, Rate select for XGS-PON or XG-PON upstream bursts of channel one;
Pin number 8—XGSPON1_SD—Receiver Signal Detect indicator for XGS-PON channel one receiver;
Pin number 9—Trig_TxDisable1—Two signals multiplex, which is selected by register: Receiver signal strength indication trigger and transmitter disable for GPON and XGS-PON of channels one;
Pin number 10—GPON1_RD+—Receive Burst Mode Non-Inverted GPON channel one Data output;
Pin number 11—GND-module ground;
Pin number 12—XGSPON1_RD−—Receive Burst Mode Inverted XGSPON channel one Data output;
Pin number 13—XGSPON1_RD+—Receive Burst Mode Non-Inverted XGSPON channel one Data output;
Pin number 14—GPON1_SD—Receiver Signal Detect indicator for GPON channel one receiver;
Pin number 15—VccR—power supply for the receiver;
Pin number 16—VccT—power supply for the transmitter;
Pin number 17—GPON1 Reset—Reset Receiver Burst Mode GPON of channel one;
Pin number 18—XGSPON1_TD+—Transmit Non-Inverted XGS-PON channel one Data Input;
Pin number 19—XGSPON1_TD−—Transmit Inverted XGS-PON channel one Data Input;
Pin number 20—GND—Module ground;
Pin number 21—GPON2 TD+—Transmit Non-Inverted GPON channel two Data Input;
Pin number 22—GPON2 TD−—Transmit Inverted GPON channel two Data Input;
Pin number 23—GND—Module ground;
Pin number 24—SDA2—Second 2-Wire Serial Interface Data Line;
Pin number 25—SCL2—Second 2-Wire Serial Interface Clock;
Pin number 26—GPON2_RD−—Receive Burst Mode Inverted GPON channel two Data output;
Pin number 27—Reset/Rateselect2—Reset Receiver Burst Mode XGS-PON, Rate select for XGS-PON or XG-PON upstream bursts of channel two;
Pin number 28—XGSPON2_SD—Receiver Signal Detect indicator for XGS-PON channel two receiver;
Pin number 29—Trig_TxDisable2—Two signals multiplex, which is selected by register: Receiver signal strength indication trigger and transmitter disable for GPON and XGS-PON of channels two;
Pin number 30—GPON2_RD+—Receive Burst Mode Non-Inverted GPON channel two Data output;
Pin number 31—GND—module ground;
Pin number 32—XGSPON2_RD−—Receive Burst Mode Inverted XGSPON channel two Data output;
Pin number 33—XGSPON2_RD+—Receive Burst Mode Non-Inverted XGSPON channel two Data output;
Pin number 34—GPON2 SD—Receiver Signal Detect indicator for GPON channel two receiver;
Pin number 35—VccR—power supply for the receiver;
Pin number 36—VccT—power supply for the transmitter;
Pin number 37—GPON2_Reset—Reset Receiver Burst Mode GPON of channel two;
Pin number 38—XGSPON2_TD+—Transmit Non-Inverted XGS-PON channel two Data Input;
Pin number 39—XGSPON2_TD−—Transmit Inverted XGS-PON channel two Data Input;
Pin number 40—GND—Module ground;

FIG. 4 is a view of the case of the DSFPDD-MPM's optical module developed with a dual SC connector for integrating the dual MPM, according to certain aspects of the invention.

The numerical references represent:
410—MSA height of the rear part;
420—MSA width of the rear part;
430—MSA length of the transceiver, rear part;
440—front length;
450—front width;
460—front height;
470—total length of the transceiver;
480—front width with pull tab;
490—ferrule distance.

FIG. 5 is an exploded view of the case and internal components of the DSFPDD-MPM optical module developed with a dual SC connector, according to certain aspects of the invention. The numerical references represent:
110—MPM optical sub-assembly.
114—printed circuit board;
510—bottom case;
520—top case;
530—actuator tines;
540—pull-tab;
550—SC MPM optical sub-assembly support;
560—case spacer;
570—gasket shield;

### DETAILED DESCRIPTION

The following detailed description has references to the figures. Parts that are common in different figures have been referred to using the same numbers. Also, the following detailed description does not limit the scope of the disclosure.

The present invention relates to a DSFPDD-MPM optical module comprising a dual SC connector, projected to be connected in an SFP-DD transceiver host, allowing it to operate as a dual GPON and XGS-PON transmitter and receiver simultaneously.

According to the main embodiment of the invention, the DSFPDD-MPM optical module (10) is comprised of at least two MPM bidirectional optical subassemblies—MPM BOSAS—(110), a control unit (111) comprising connection and processing means adapted to drive and control said BOSAs (110) and a high-speed electrical interface—HSEI—(112) adapted to provide connection to the SFP-DD transceiver host Optical Network Units. These elements comprising the DSFPDD-MPM optical module (10) are housed in a case (113) which is to be installed inside the SFP-DD transceiver host cage of a GPON and XGS-PON MPM OLT.

FIG. 1 illustrated the block diagram of an exemplary embodiment of the DSFPDD-MPM optical module (10) of the invention. It is comprised of the case (113) housing two MPM-BOSA (110) for GPON and XGS-PON connection, the control unit (111), and the high-speed electrical interface (112).

Each of the MPM-BOSA (110) is composed of a laser working on XGS-PON downstream wavelength at 9.95 Gbit/s, a dual-rate burst mode receiver working on XGS-PON upstream wavelength at 2.48 Gbit/s and 9.95 Gbit/s, a laser working on GPON downstream wavelength at 2.48 Gbit/s and a burst mode receiver working on GPON upstream wavelength at 1.24 Gbit/s. The MPM-BOSA (110) further includes an SC ferrule to allow the connection to an SC optical fiber connector.

The control unit (111) is shown in FIG. 2 and is adapted to control the two MPM-BOSAS (110). For that purpose, the control unit (111) comprises four modulation sub-units (210) and a microcontroller (220), besides the required circuit electronics that comprise resistors, capacitors, power supply (230), and ferrite bead. The modulation sub-units (210) comprise laser drivers and limiting amplifiers adapted to drive and modulate the specific technology lasers and to amplify the electrical signals from the single and dual-rate burst mode receivers of the MPM-BOSAS (110). The microcontroller (220) is configured to control the modulation sub-units (210) and to communicate with the SFP-DD host through the HSEI (112). The microcontroller (210) is also configured to control the MPM-BOSAs power supplies (230). In one embodiment, each of the MPM-BOSA (110) is connected to the control unit (111) through four flex printed circuit boards (114). More particularly, each of the MPM-BOSA (110) is connected to the modulation sub-units (210) of the control unit (111), and in particular to the respective laser driver and limiting amplifier through the flexible printed circuit board (114), to guarantee the electronic performance. In another embodiment, the control unit (111) is mounted in a printed circuit board (115) containing all the necessary electrical connections between the different elements to control and drive each of the MPM-BOSAs (110).

The forty pin HSEI (112) is configured to provide a high-speed interconnection to the SFP-DD transceiver host, to transmit electrical signals that were transformed by the DSFPDD-MPM optical module (10) from the different PON data received. Similarly, the DSFPDD-MPM optical module (10) may receive electrical signals from the SFP-DD transceiver host via said port connector, to be transformed to optical signals and sent to a fiber network via optical connection.

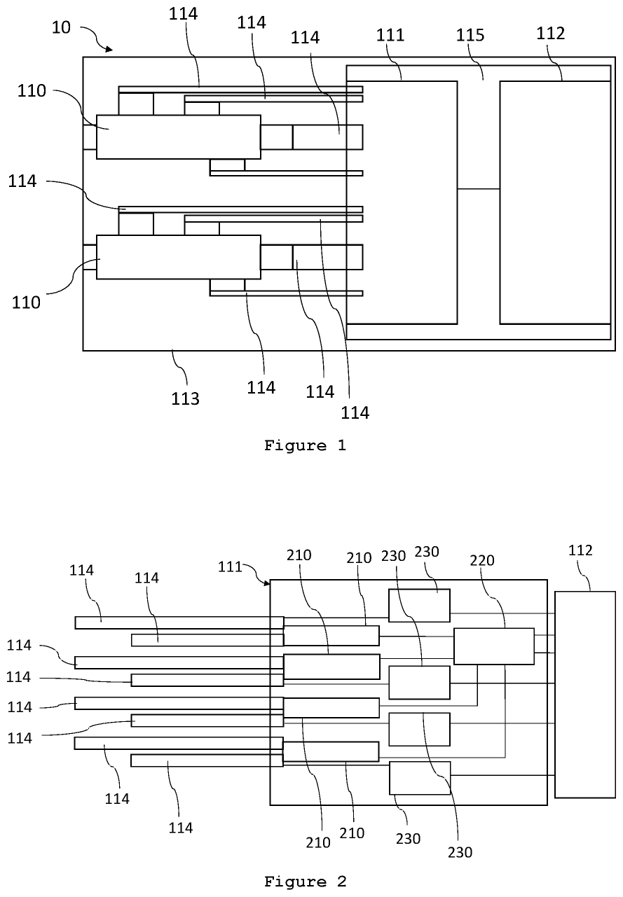

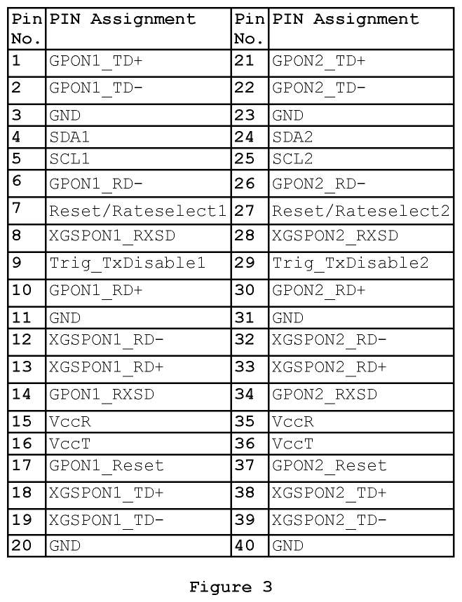

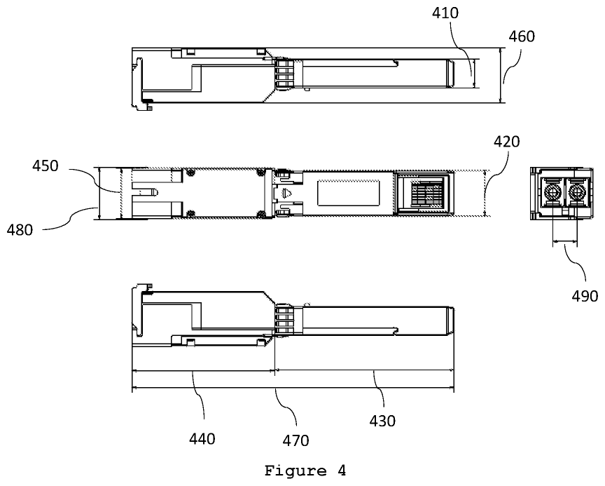

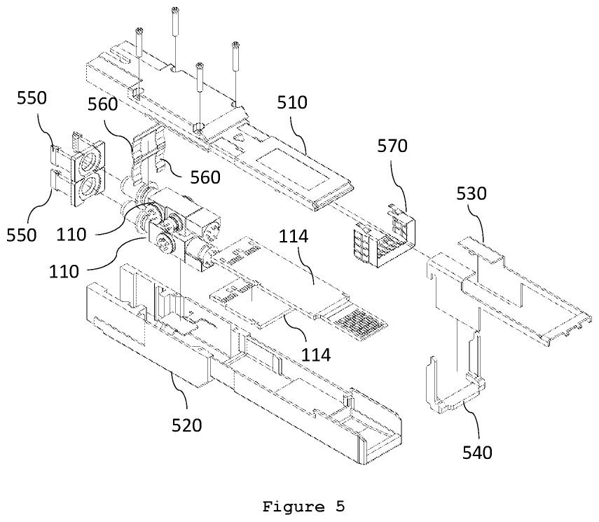

For the connection with the SFP-DD transceiver host, the HSEI (112) comprises a port connector including a plurality of connection pins. In a particular embodiment, the port connector of the forty pins HSEI (112) is provided with a specific contact assignment, to ensure adaptability and compatibility with the state-of-the-art SFP-DD transceiver hosts. Under a particular embodiment of the HSEI (112), FIG. 3 depicts a port connector and respective receptacle which is comprised of forty pins. In the embodiment illustrated in FIG. 3, pin 9 and pin 29 are used to both disable the GPON and XGS-PON lasers transmission of each of the MPM-BOSAs and to measure the optical input power on the receivers of the GPON and XGS-PON MPM-BOSAS, representing the remote signal strength indication-RSSI. These pin functions are selected on a memory pin map of the SFP-DD module, through the SDA1 (data line) and SCL1 (clock line) pins or SDA2 (data line) and SCL2 (clock line) pins, stored on the memory of the microcontroller (220), to act as transmitter disable of the GPON channel one and XGS-PON channel one, GPON channel two and XGS-PON channel two of the MPM-BOSA (110), or as RSSI of the GPON channel one and XGS-PON channel 1, GPON channel 2 and XGS-PON channel 2 of the MPM-BOSA (110).

FIG. 4 illustrates the mechanical case (113) design of the DSFPDD-MPM optical module (10) developed. It assumes a standard SFP-DD Transceiver Multisource Agreement (MSA) size inside a cage assembly: MSA height of the rear part (410), MSA width of the rear part (420), and MSA length of transceiver outside of the cage to rear (430) to fit on a standard SFP-DD Cage Assembly of the SFP-DD transceiver host. The DSFPDD-MPM optical module (10) dimensions outside of the cage MSA, to fit the two MPM-BOSA and the dual SC connector, assume a specific front length (440) of 43.00 mm, front width (450) of 15.20 mm, front width with pull tab (480) of 15.90 mm, a front height (460) of 16.50 mm and BOSA ferrule distance (490) of 7.35 mm. The total length of the transceiver (470) is 97.15 mm. The dual SC connector is placed vertically but can also be placed horizontally.

The DSFPDD-MPM optical module comprises a case (113) which includes two SC BOSA supports (550) and two case spacer (560) adapted to accommodate the installation of the MPM-BOSA (110). Additionally, and as shown in FIG. 5, the case (113) may also comprise other mechanical parts such as a bottom case (510), a top case (520), a gasket shield (570), one actuator tine (530) to allow the extraction of the DSFPDD-MPM optical module (10) from the SFP-DD transceiver host case, and a pull-tab (540) to allow to manually pull the DSFPDD-MPM optical module (10).

The DSFPDD-MPM optical module mechanical parts, (510), (520), (530), (540), (560) are made from several types of metallic materials as zinc alloys, zamak 2, zamak 3, or aluminum. The SC BOSA supports (550) are manufactured in plastic or metal.

The physical geometry of the DSFPDD-MPM optical module (10) developed is to be such that it may fit within the receptacle case of a conventional GPON and XGS-PON MPM OLT transceiver equipped with SFP-DD transceiver hosts.

The DSFPDD-MPM optical module (10) developed may be one of the multiple SFPDD-MPM optical modules (10) incorporated into SFP-DD transceiver hosts of a GPON and XGS-PON MPM OLT. In certain embodiments, inserting an SFPDD-MPM optical module (10) into an SFP-DD transceiver host configured to operate just in GPON or XGS-PON may result in the DSFPDD-MPM optical module (10) being only able to establish a single optical connection.

As will be clear to one skilled in the art, the present invention should not be limited to the embodiments described herein, and several changes are possible which remain within the scope of the present invention.

Of course, the preferred embodiments shown above are combinable, in the different possible forms, being herein avoided the repetition of all such combinations.

1. A dual small form-factor pluggable double-density multiple passive optical network module—DSFPDD-MPM optical module projected to be incorporated in a small form-factor double density—SFP—DD transceiver host of a multiple passive optical network line—MPM-PON-OLT, ten-gigabit passive optical network line terminal—XGS-PON-OLT, two-point-five gigabit passive optical network line terminal—GPON-OLT characterized by comprising:
a case projected to house:
two multiple passive optical network modules-bidirectional optical subassemblies—MPM-BOSAs—, wherein each MPM-BOSA is configured to provide connection to an XGS-PON and GPON OLT; each BOSA comprises an SC ferrule adapted to provide connection to an SC optical fiber connector;
a control unit comprising connection means, adapted to provide connection to the MPM-BOSAs, and a microcontroller comprising processing means configured to control an operation of the MPM-BOSAs; and
a forty-pin high-speed electrical interface—HSEI—adapted to provide a connection between the microcontroller and an SFP double density transceiver host where the DSFPDD-MPM is incorporated.

2. The DSFPDD-MPM optical module according to claim 1, wherein each of the MPM-BOSA comprises two lasers, adapted to operate at the ten-gigabit passive optical network—XGS-PON, and the two-point-five gigabit passive optical network—GPON, at respectively downstream wavelengths at 9.95 Gbit/s and 2.48 Gbit/s, one dual rate burst mode receiver adapted to operate at XGS-PON upstream wavelength 9.95 Gbit/s, and 2.48 Gbit/s, and a burst mode receiver adapted to operate at 1.24 Gbit/s GPON upstream wavelength.

3. The DSFPDD-MPM optical module according to claim 1, wherein the control unit comprises:
a modulation sub-unit including four laser drivers and limiting amplifiers elements, adapted to drive and modulate the lasers and to amplify electrical signals from a single and dual-rate burst mode receiver of the MPM-BOSAs; and wherein, the microcontroller is further configured to control the operation of the modulation sub-unit.

4. The DSFPDD-MPM optical module according to claim 3, wherein the connection between each MPM-BOSA and the respective laser driver and limiting amplifier of each modulation sub-unit is provided through flex printed circuit board.

5. The DSFPDD-MPM optical module according to claim 1, wherein the forty pins HSEI is configured to provide connection to the SFP-DD transceiver host where the DSFPDD-MPM is incorporated employing a port connector.

6. The DSFPDD-MPM optical module according to claim 5, wherein the port connector is comprised by a plurality of pins, and wherein the microcontroller further comprises memory means adapted to store a memory pin map of the port connector; the microcontroller being further programmed to select the pin function of each pin of the port connector based on the memory pin map.

7. The DSFPDD-MPM optical module according to claim 6, wherein the port connector is comprised of forty pins.

8. The DSFPDD-MPM optical module according to claim 1, wherein the case comprises the following parts: two SC MPM-BOSA support and a case spacer to accommodate the installation of the two MPM-BOSA.

9. The DSFPDD-MPM optical module according to claim 8 wherein the case further comprises the following parts:
a bottom and a top part;
one actuator tine adapted to allow the extraction of the DSFPDD-MPM optical module from the SFP-DD transceiver host's cage where it is incorporated;
a pull-tab to allow a manual pull of the DSFPDD-MPM module.

10. The SFPDD-MPM optical module according to claim 8, wherein the MPM SC BOSA support is made from a plastic material.

11. The DSFPDD-MPM optical module according to claim 8 wherein the elements of the case are made from metal.

12. The DSFPDD-MPM optical module according to claim 11, wherein the case is made from zinc alloys, zamak 2, zamak 3, or aluminum.

13. The DSFPDD-MPM optical module according to claim 1, wherein the size of the case is standardized to fit within a receptacle cage of an SFP-DD transceiver host.

14. An SFP-DD transceiver host comprising at least one DSFPDD-MPM optical module according to claim 1.

15. A XGS-PON-OLT comprising at least one SFP-DD transceiver host according to claim 14.

16. A GPON-OLT comprising at least one SFP-DD transceiver host according to claim 14.

17. A Multi-PON OLT comprising at least one SFP-DD transceiver host according to claim 14.
